(19) United States
(12) Patent Application Publication
(10) Pub. No.: US 2026/0059195 A1
(43) Pub. Date: Feb. 26, 2026

(54) IMAGE PICKUP APPARATUS, ITS CONTROL METHOD, AND STORAGE MEDIUM

(71) Applicant: CANON KABUSHIKI KAISHA, Tokyo (JP)

(72) Inventor: Shimpei ITAGAKI, Tokyo (JP)

(21) Appl. No.: 19/265,454

(22) Filed: Jul. 10, 2025

(30) Foreign Application Priority Data
Aug. 21, 2024 (JP) 2024-139498

(51) Int. Cl. H04N 23/667; H04N 23/63

(52) U.S. Cl. CPC H04N 23/667; H04N 23/633

(57) ABSTRACT

Image pickup apparatuses, control methods, and storage media are provided herein. One or more image pickup apparatuses configured to acquire a plurality of images through continuous shooting include one or more memories storing instructions, and one or more processors that, upon execution of the instructions, operate to acquire information on a selection of a mode that automatically switches between use and nonuse of a function of combining the plurality of images to generate a single image, control an image magnification, and make a control method of the image magnification different between a case where the mode is selected and a case where the mode is not selected.

### BACKGROUND

### Field of the Technology

The present disclosure relates to one or more embodiments of an image pickup apparatus, its control method, and a storage medium.

### Description of the Related Art

For image pickup apparatuses such as cameras having an image sensor, a technology has conventionally been known which acquire an image equivalent to long exposure having no camera shake by aligning a plurality of images acquired in a short time and combining them (hereinafter referred to as image combination and stabilization (or image-combination image-stabilization)) (see U.S. Pat. No. 4,418,632).

The image combination and stabilization performs the image alignment during image combination, and thus the outer peripheral portion of the captured image may be deleted, and the image magnification may differ between an image acquired by imaging using image combination and stabilization and an image acquired by normal imaging without using image combination and stabilization. Some image pickup apparatuses have a mode that automatically switches between use of the image combination and stabilization and nonuse of the image combination and stabilization, but in this case, they may generate images having different image magnifications for each imaging type.

### SUMMARY

One or more embodiments of an image pickup apparatus according to one or more aspects of the present disclosure may be configured to acquire a plurality of images through continuous shooting and include one or more memories storing instructions; and one or more processors that, upon execution of the instructions, operate to acquire information on a selection of a mode that automatically switches between use and nonuse of a function of combining the plurality of images to generate a single image, control an image magnification, and make a control method of the image magnification different between a case where the mode is selected and a case where the mode is not selected. One or more embodiments of a control method of the above image pickup apparatus may also constitute anther aspect of the present disclosure. A storage medium storing a program that causes a computer to execute the above one or more control methods also constitutes another aspect of the present disclosure.

Features of the present disclosure will become apparent from the following description of embodiments with reference to the attached drawings. The following description of embodiments is described by way of example.

### BRIEF DESCRIPTION OF THE DRAWINGS

FIGS. 1A and 1B explain an image pickup apparatus according to this embodiment of the present disclosure.

FIGS. 2A, 2B, 2C, and 2D illustrate images acquired by imaging using image combination and stabilization.

FIG. 3 illustrates an example of images in a group photo in a case where an automatic mode is selected.

FIG. 4 is a flowchart illustrating image magnification control processing according to this embodiment.

### DESCRIPTION OF THE EMBODIMENTS

In the following, the term “unit” may refer to a software context, a hardware context, or a combination of software and hardware contexts. In the software context, the term “unit” refers to a functionality, an application, a software module, a function, a routine, a set of instructions, or a program that can be executed by a programmable processor such as a microprocessor, a central processing unit (CPU), or a specially designed programmable device or controller. A memory contains instructions or programs that, when executed by the CPU, cause the CPU to perform operations corresponding to units or functions. In the hardware context, the term “unit” refers to a hardware element, a circuit, an assembly, a physical structure, a system, a module, or a subsystem. Depending on the specific embodiment, the term “unit” may include mechanical, optical, or electrical components, or any combination of them. The term “unit” may include active (e.g., transistors) or passive (e.g., capacitor) components. The term “unit” may include semiconductor devices having a substrate and other layers of materials having various concentrations of conductivity. It may include a CPU or a programmable processor that can execute a program stored in a memory to perform specified functions. The term “unit” may include logic elements (e.g., AND, OR) implemented by transistor circuits or any other switching circuits. In the combination of software and hardware contexts, the term “unit” or “circuit” refers to any combination of the software and hardware contexts as described above. In addition, the term “element,” “assembly,” “component,” or “device” may also refer to “circuit” with or without integration with packaging materials.

Referring now to the accompanying drawings, a detailed description will be given of embodiments according to the present disclosure. Corresponding elements in respective figures will be designated by the same reference numerals, and a duplicate description thereof will be omitted.

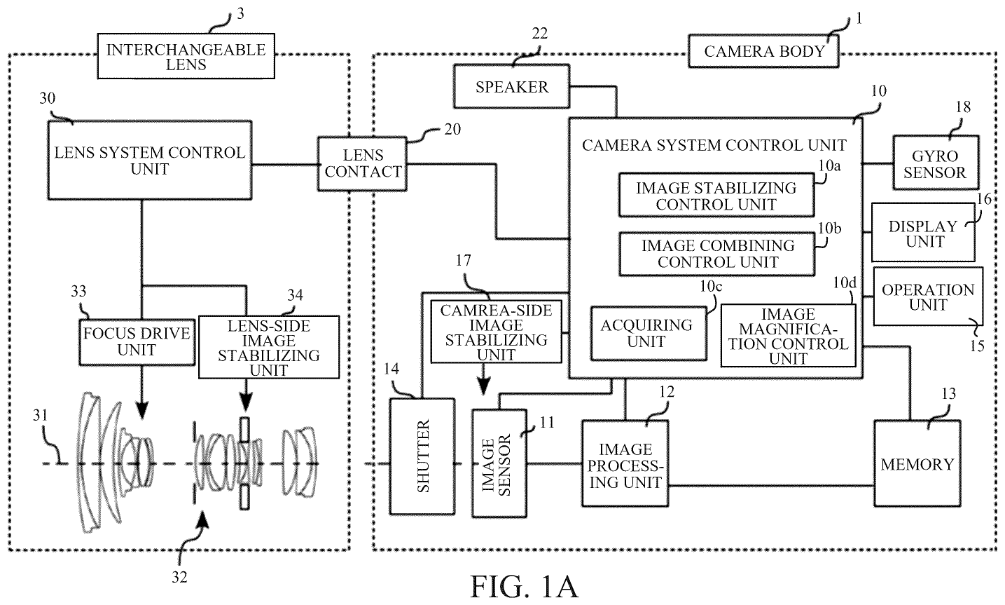

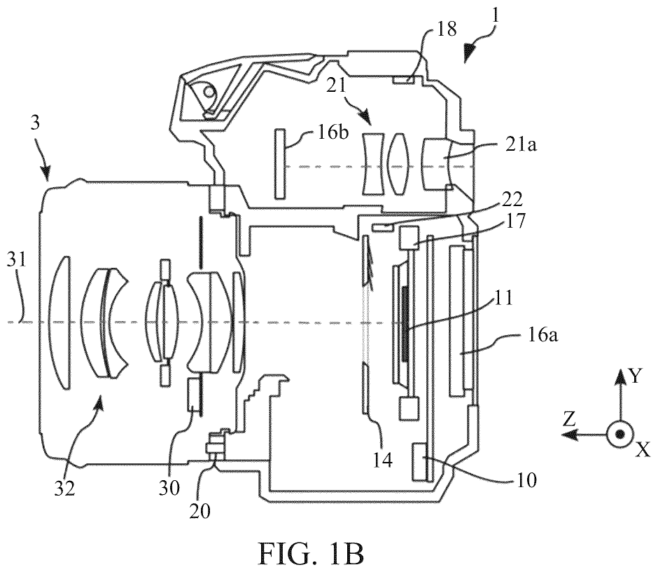

FIGS. 1A and 1B explain a digital camera as an example of an image pickup apparatus according to this embodiment of the present disclosure. FIG. 1A is a block diagram of the digital camera. FIG. 1B is a central sectional view of the digital camera.

The digital camera includes a camera body 1 and an interchangeable lens 3, and can capture a plurality of images through continuous shooting with a single imaging command. The camera body 1 and the interchangeable lens 3 can exchange electrical signals via a lens contact 20 that is electrically connected.

The camera body 1 includes a camera system control unit 10, an image sensor 11, an image processing unit 12, a memory unit 13, a focal plane shutter (shutter hereinafter) 14, an operation unit 15, a display unit 16, a viewfinder optical system 21, and a speaker 22. The camera system control unit 10 includes a CPU (Central Processing Unit) and the like, and controls the camera body 1 including communication with the interchangeable lens 3. The camera system control unit 10 also includes an image stabilizing control unit 10a, an image combining control unit 10b, an acquiring unit 10c, and an image magnification control unit (control unit) 10d. The acquiring unit 10c acquires information on the selection of a mode for automatically switching between use (enabled state) and nonuse (disabled state) of a function for combining a plurality of images to generate a single image. In this embodiment, the acquiring unit 10c acquires information on the selection of an automatic mode, which will be described later. The control unit 10d controls the image magnification. The image sensor 11 photoelectrically converts an object image formed by an imaging optical system 32 of the interchangeable lens 3. An analog electric signal output from the image sensor 11 is converted into a digital electric signal (image signal) by an unillustrated A/D converter. The image processing unit 12 includes a white balance circuit, a gamma correction circuit, an interpolation calculation circuit, and the like, and performs various image processing for the digital electric signal to generate image data. The memory unit 13 records information such as the image data generated by the image processing unit 12. The shutter 14 includes a shutter curtain consisting of a front curtain and a rear curtain, and controls the shielding and passage of light from the imaging optical system 32 to the image sensor 11 by moving the shutter curtain within an opening. The operation unit 15 recognizes the user's operation. The display unit 16 displays an image and the like. The display unit 16 includes a rear LCD unit 16a provided on the rear surface of the camera body 1, and a viewfinder display unit 16b disposed in the viewfinder optical system 21 and viewable through an eyepiece lens 21a. The user can arbitrarily switch between the rear LCD unit 16a and the viewfinder display unit 16b for display. The speaker 22 reproduces an operation sound for settings and shutter sounds during imaging as necessary.

The camera body 1 further includes a camera-side image stabilizing unit 17 and a gyro sensor 18. The camera-side image stabilizing unit 17 shifts the image sensor 11 in a direction including a component in a direction substantially orthogonal to an optical axis 31 of the imaging optical system 32 and rotates the image sensor 11 around an axis substantially parallel to the optical axis 31. The gyro sensor 18 is an angular shake sensor configured to detect the angular velocity of rotation around each of the X-axis, Y-axis, and Z-axis of the camera body 1. The gyro sensor 18 may be configured in a single package. The same package may be disposed in three units in the respective axial directions.

The interchangeable lens 3 includes a lens system control unit 30, the imaging optical system 32, a focus drive unit 33, and a lens-side image stabilizing unit 34. The lens system control unit 30 controls the interchangeable lens 3. The focus drive unit 33 moves the focus lens included in the imaging optical system 32. The lens-side image stabilizing unit 34 shifts the shift lens included in the imaging optical system 32 in a direction including a component of a direction substantially orthogonal to the optical axis 31.

The camera system control unit 10 generates a timing signal and the like for imaging and outputs it to each unit. In a case where a release button included in the operation unit 15 is pressed down to accept an imaging instruction, the camera system control unit 10 controls the image sensor 11 in accordance with the instruction and transmits a command signal to the lens system control unit 30. The release button can detect a so-called half-press operation, which is a first step in the press amount, and a so-called full-press operation, which is a second step in the press amount. In a case where the half-press operation of the release button is detected, the camera system control unit 10 issues a command for an imaging preparation operation, such as an autofocus (AF hereinafter) operation. In a case where a fully pressing operation of the release button is detected, the camera system control unit 10 drives the shutter 14 to start an exposure operation for still image capturing. Depending on the setting, it is also possible to perform exposure operations for still image capturing a plurality of times in succession by pressing the release button once.

Next follows a description of image stabilization. First, the camera-side image stabilizing unit 17 will be described. The image stabilizing control unit 10a calculates an angular shake component of the camera body 1 by performing filtering processing and integration processing for the angular velocity detected by the gyro sensor 18, and generates a drive signal for the camera-side image stabilizing unit 17. The camera-side image stabilizing unit 17 uses the drive signal to shift the image sensor 11 in a direction that includes a component in a direction approximately orthogonal to the optical axis 31 and to rotate it around an axis approximately parallel to the optical axis 31, thereby achieving image stabilization. Shifting the image sensor 11 can correct rotational shake in the pitch and yaw directions of the camera body 1, and rotating the image sensor 11 around an axis approximately parallel to the optical axis 31 can correct roll shake of the camera body 1.

Similarly, the lens-side image stabilizing unit 34 receives the drive signal generated by the image stabilizing control unit 10a via the lens contact 20 and the lens system control unit 30, and is driven. The lens-side image stabilizing unit 34 shifts the shift lens in a direction that includes a component in a direction approximately orthogonal to the optical axis 31, thereby correcting rotational shake in the pitch and yaw directions of the camera body 1.

The image combination and stabilization will be discussed below. A method of increasing the exposure time (long-exposure imaging hereinafter) is generally known as a method for properly performing imaging in environments where sufficient light is not available. However, the longer the exposure time is, the more significant the influence of camera shake is, and even the image stabilizing operation described above cannot fully correct this, and the image may have a large blur amount. The image processing unit 12 combines a plurality of images while aligning the images chronologically output from the image sensor 11 (hereinafter referred to as image combination and stabilization), and thereby generates a single image with a reduced blur. The image processing unit 12 aligns the images by translational movement with two-pixel accuracy using the motion vector between the images. The image combined by the image processing unit 12 is recorded in the memory unit 13. In the image combination and stabilization, a predetermined number of images are captured continuously when the user presses the release button included in the operation unit 15 once.

In the image combination and stabilization, the exposure time is divided to be the same as that of long-exposure imaging. For example, in the case of long-exposure imaging with an exposure time of 1 second, an image with a reduced blur and exposure equivalent to that of long-exposure imaging can be obtained by aligning and combining ten images captured continuously with an exposure time of 1/10 second. However, in the image combination and stabilization, it is arduous for the user to set the exposure time per image and the number of images to be captured each time. In this embodiment, the image combining control unit 10b can automatically determine a proper setting, and perform imaging using image combination and stabilization. In this embodiment, the camera system control unit 10 can set a mode (automatic mode hereinafter) that can automatically determine whether to perform imaging using the image combination and stabilization (automatically switches between use and nonuse of the image combination and stabilization function).

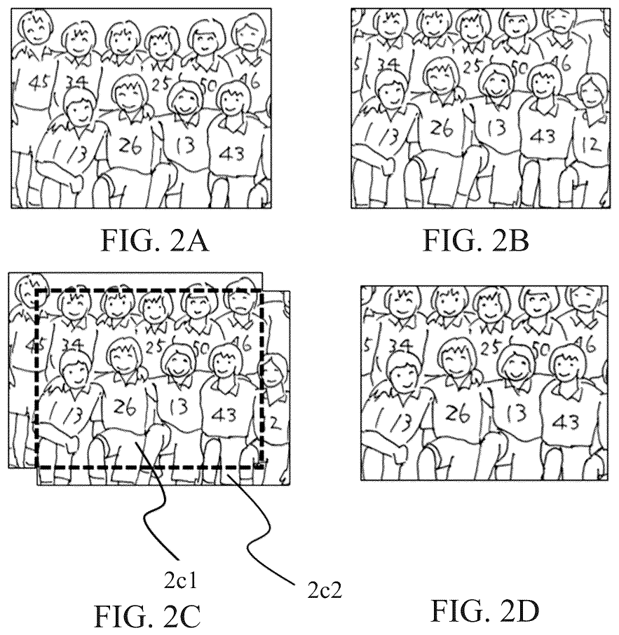

Referring now to FIGS. 2A, 2B, 2C, and 2D, a description will be given of a difference in image magnification between normal imaging and imaging using image combination and stabilization. FIGS. 2A, 2B, 2C, and 2D illustrate images acquired by imaging using the image combination and stabilization. FIGS. 2A, 2B, 2C, and 2D illustrate an example in which two images are combined. FIG. 2A is the first image acquired by imaging using the image combination and stabilization. FIG. 2B is the second image acquired by the imaging using image combination and stabilization. FIG. 2C illustrates a state in which two images are aligned and combined. FIG. 2D is an image output after the combination is completed.

In a case where the user issues an imaging instruction, the first image in FIG. 2A and the second image in FIG. 2B are acquired. In a case where the two images are compared, they are consecutively captured, but an angle of view shifts due to camera shake by the photographer. The angle-of-view shift is normally expected to be minute, on the order of a few pixels, but this embodiment assumes a significant shift for better understanding.

In aligning and combining the first and second images, the first image is used as a reference, and the second image is superimposed on top of it by a method such as additive averaging, and then combined. At this time, the two images are combined by shifting their positions, so in the state during alignment and combination in FIG. 2C, there are a portion 2c1 where the two images are superimposed, surrounded by a broken line, and a portion 2c2 outside the broken line. Thereafter, in order to make the combined image rectangular, only the portion 2c1 is left and the portion 2c2 is deleted. In other words, the image magnification of the combined image changes compared to the two images before combination, and an imageable area (area to be output) becomes narrower.

The automatic mode has the following problems: In the automatic mode, the camera system control unit 10 automatically determines whether to use the image combination and stabilization. More specifically, in the automatic mode, whether to use the image combination and stabilization is determined based on a relationship between a first imaging condition among the imaging conditions and a threshold value. The first imaging condition is, for example, an imaging condition in which camera shake is expected to occur, such as a shutter speed. For example, in a case where the shutter speed is smaller than the threshold value, it may be determined that image combination and stabilization is used for imaging, and in a case where the shutter speed is larger than the threshold value, it may be determined that image combination and stabilization is not used for imaging. Here, in a case where the first imaging condition is equal to the threshold value, imaging using image combination and stabilization and normal imaging will be mixed, and images with different image magnifications may be captured each time. The first imaging condition equal to the threshold value includes not only the case where the first imaging condition is strictly equal to the threshold value, but also the case where the first imaging condition is near the threshold value (substantially or approximately equal to the threshold value).

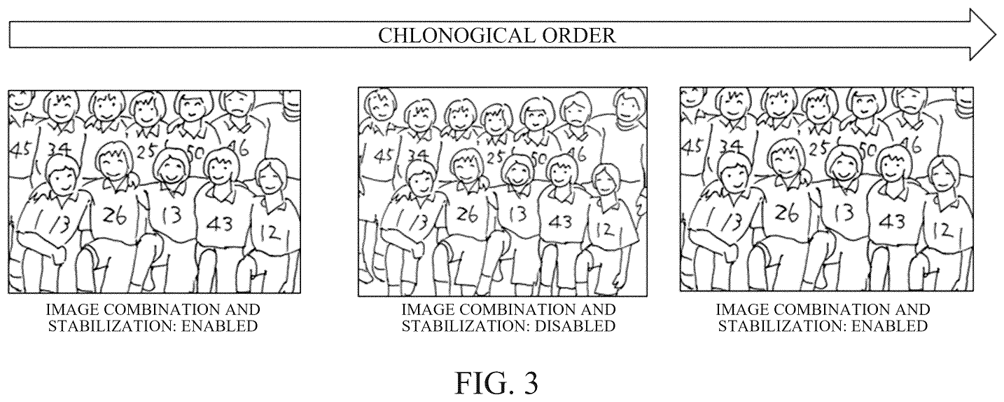

FIG. 3 illustrates an example of images in a group photo in a case where the automatic mode is selected. In capturing the group photo, continuous shooting may be performed by continuously issuing an imaging instruction in preparation for cases where a person to be imaged has closed his eyes. In a case where the imaging condition at that time is near a threshold value for determining whether or not to use image combination and stabilization, the continuously shot images may include images with different image magnifications. In this case, some people may be cut off from the group photo that should include everyone, or conversely, a part not to be imaged may be imaged. FIG. 3 illustrates images captured in chronological order from left to right. The first and third images are images captured using image combination and stabilization. The second image is an image captured by normal imaging. The first and third images captured using the image combination and stabilization and the second image captured by normal imaging have different image magnifications.

Accordingly, this embodiment makes the control method of the image magnification different between the case where the automatic mode is selected and the case where the automatic mode is not selected. In this embodiment, in a case where the automatic mode is selected, the image magnification is controlled to be constant. In this embodiment, the image magnification is fixed to the image magnification for imaging using image combination and stabilization.

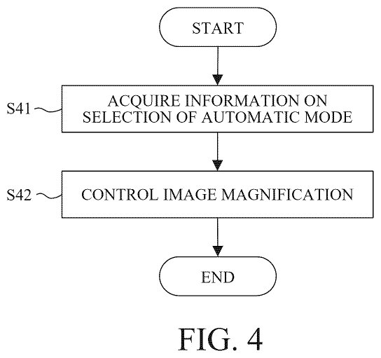

Referring now to FIG. 4, a description will be given of the control processing of the image magnification according to this embodiment. FIG. 4 is a flowchart illustrating the control processing of the image magnification according to this embodiment.

In step S41 (acquiring step), the acquiring unit 10c acquires information on the selection of the automatic mode.

In step S42 (control step), the control unit 10d controls the image magnification. The control unit 10d makes the control method of the image magnification different between the case where the automatic mode is selected and the case where the automatic mode is not selected. In this embodiment, the control unit 10d makes control so as to make the image magnification constant in a case where the automatic mode is selected. For example, the image magnification may be fixed to the image magnification for imaging using the image combination and stabilization. In a case where the automatic mode is selected, the control unit 10d may provide display control so as to cause the display unit 16 to live-view-display an image corresponding to the image magnification for imaging using image combination and stabilization. In a case where the automatic mode is selected, the control unit 10d may cause the display unit 16 to live-view-display an image corresponding to the image magnification for imaging without using image combination and stabilization, and may superimpose an index corresponding to the image magnification for imaging using image combination and stabilization on the image. The superimposed index may be, for example, a frame indicating the boundary of the imageable area, or a pointer indicating the four corners of the imageable area. In addition, the control unit 10d may cause the display form different (for example, by changing the color or resolution) between the imageable area and another area (area outside the imageable area).

Thus, equalizing the image magnification for imaging without using image combination and stabilization and the image magnification for imaging using image combination and stabilization can restrain images with different image magnifications from being captured for each imaging.

This embodiment has discussed the automatic mode for automatically determining whether or not to perform imaging using image combination and stabilization as an example, but the present disclosure is not limited to this embodiment. For example, the present disclosure is also applicable to a mode for automatically determining whether to perform imaging using a so-called HDR function that combines a plurality of images with different exposure corrections.

As described above, an image captured using image combination and stabilization has a different image magnification from that of normal imaging, and the imageable area is narrower. In general, the imageable area may not be narrower, and may be as wide as possible. Accordingly, in the automatic mode, control may be made so as to make the image magnification constant in a case where continuous shooting is performed by continuously issuing an imaging instruction. In a case where images with different image magnifications are mixed in continuously captured images captured at the same time, the user may feel uncomfortable, but if the images are captured at different timings and with different angles of view, the user will not feel uncomfortable even when the image magnifications are different. Accordingly, maintaining the image magnification except during continuous shooting can restrain the imageable area from becoming narrow during normal imaging.

In the automatic mode, the image magnification may be fixed to that for imaging using image combination and stabilization only in a case where it is determined that an imaging instruction has been issued near the threshold value for determining whether or not the image combination and stabilization function is enabled (used). In other cases, that is, in a case where it is determined that the imaging does not involve a mixture of the enabled state (use) and disabled state (nonuse) of the image combination and stabilization, the image magnification is not changed. This configuration can reduce the likelihood that the imageable area becomes narrower during normal imaging.

In the automatic mode, the image magnification may not be changed in a case where continuous shooting is performed by moving the digital camera significantly up, down, left, right, etc. The state in which continuous shooting is performed by moving the digital camera significantly up, down, left, right, etc. refers to a state in which a moving amount per unit time of the digital camera during the continuous shooting period is greater than a predetermined amount. The use and nonuse of the image combination and stabilization are mixed and the user often feels uncomfortable with different image magnifications mainly when the images are captured with the same angle of view. In a case where continuous shooting is performed by moving the digital camera significantly, angles of view of all images are different, so even if the image magnifications of all images are the same, the images to be captured are different. Therefore, it is unnecessary to equalize the image magnification for imaging without using image combination and stabilization and the image magnification for imaging using image combination and stabilization. As described above, this configuration can reduce the likelihood that the imageable area becomes narrower during normal imaging.

As mentioned above, continuous shooting for continuously issuing an imaging instruction in the automatic mode may cause images with different image magnifications to be mixed and provide the user with a sense of discomfort. On the other hand, a method of changing the image magnification to reduce the sense of discomfort has been discussed, but the sense of discomfort may also be reduced by changing the automatic-mode switching method. That is, in a case where continuous shooting that continuously issues imaging instructions in the automatic mode, use and nonuse of the image combination and stabilization may not be switched. Thereby, images with different image magnifications can be restrained from being captured for each imaging during continuous shooting.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This embodiment can provide an image pickup apparatus that can suppress discomfort caused by images with different image magnifications in a mode in which use and nonuse of an image combination function are automatically switched.

This application claims the benefit of Japanese Patent Application No. 2024-139498, which was filed on Aug. 21, 2024, and which is hereby incorporated by reference herein in its entirety.

What is claimed is:

1. An image pickup apparatus configured to acquire a plurality of images through continuous shooting, the image pickup apparatus comprising:
one or more memories storing instructions; and
one or more processors that, upon execution of the instructions, operate to:
acquire information on a selection of a mode that automatically switches between use and nonuse of a function of combining the plurality of images to generate a single image,
control an image magnification, and
make a control method of the image magnification different between a case where the mode is selected and a case where the mode is not selected.

2. The Image pickup apparatus according to claim 1, wherein the function is a function of aligning and combining the plurality of images to generate the image with a reduced blur.

3. The image pickup apparatus according to claim 1, wherein the one or more processors operate to perform control so as to make the image magnification constant in a case where the mode is selected.

4. The image pickup apparatus according to claim 1, wherein in a case where the mode is selected, the one or more processors operate to perform control so as to make the image magnification to be equal to that when the function is used.

5. The image pickup apparatus according to claim 1, wherein the one or more processors operate to perform control so as to make constant the image magnification in a case where the mode is selected and the continuous shooting is performed that continuously issues an imaging instruction.

6. The image pickup apparatus according to claim 1, wherein in the mode, whether to use the function is determined based on a relationship between a first imaging condition among imaging conditions and a threshold value, and
wherein the one or more processors operate not to change the image magnification in a case where the mode is selected and the first imaging condition is the threshold value.

7. The image pickup apparatus according to claim 1, wherein the one or more processors operate not to change the image magnification in a case where the mode is selected and the continuous shooting is performed that continuously issues an imaging instruction while a moving amount per unit time of the image pickup apparatus is greater than a predetermined amount.

8. The image pickup apparatus according to claim 1, wherein in a case where the mode is selected and the continuous shooting is performed that continuously issues an imaging instruction, the use and nonuse of the function are not switched in the mode.

9. The image pickup apparatus according to claim 1, further comprising a display unit,
wherein in a case where the mode is selected, the one or more processors operate to cause the display unit to live-view-display an image corresponding to the image magnification when the function is used.

10. The image pickup apparatus according to claim 1, further comprising a display unit,
wherein in a case where the mode is selected, the one or more processors operate to:
cause the display unit to live-view-display an image corresponding to an image magnification when the function is not used, and
superimpose an index corresponding to an image magnification when the function is used on the image.

11. The image pickup apparatus according to claim 1, further comprising a display unit,
wherein in a case where the mode is selected, the one or more processors operate to:
cause the display unit to live-view-display an image corresponding to an image magnification when the function is not used, and
make a display form different between an area in the image corresponding to an image magnification when the function is used and another area.

12. A control method for use with an image pickup apparatus configured to acquire a plurality of images through continuous shooting, the control method comprising:
acquiring information on a selection of a mode that automatically switches between use and nonuse of a function of combining the plurality of images to generate a single image; and
controlling an image magnification,
wherein controlling makes a control method of the image magnification different between a case where the mode is selected and a case where the mode is not selected.

13. A non-transitory computer-readable storage medium storing a program that causes a computer to execute the control method according to claim 12.
